(19) United States
(12) Patent Application Publication
(10) Pub. No.: US 2016/0232761 A1
(43) Pub. Date: Aug. 11, 2016

(54) LONG RANGE PORTABLE SECURITY DEVICE THAT BROADCASTS ALERTS UPON DETECTING INTRUSION EARLY BY MONITORING VIBRATION

(71) Applicants: Seshagiri Venkatesh Prasanna, Bangalore (IN); Shubha Prasanna, Bangalore (IN)

(72) Inventors: Seshagiri Venkatesh Prasanna, Bangalore (IN); Shubha Prasanna, Bangalore (IN)

(21) Appl. No.: 14/615,880

(22) Filed: Feb. 6, 2015

(51) Int. Cl. G08B 13/02

(52) U.S. Cl. CPC G08B 13/02

(57) ABSTRACT

A low power portable vibration detector and a method for alerting a user or authorities irrespective of their proximity when their assets are tampered with is disclosed. The device comprises of a circuit board, an antenna, a speaker, a microphone and a power source all enclosed in a housing. Upon sensing a vibration that exceeds a predetermined amount, a voltage change triggers a processing unit that in turn triggers an alarm and/or broadcasts an alert via close/long range wireless networks, and/or the internet and/or via telephonic land lines. The device generates alerts when an attempt is made to disable or tamper with its functionality as well. Using this device, the user can also listen in and talk through the device to startle intruders. Thus the system described employs a vibration detector and its associated hardware to accomplish the task of serving as a very reliable early intrusion detection system.

### FIELD OF THE INVENTION

The present invention relates generally to sensors and subsystems that serve as an intrusion detection system or security systems in general. In particular, the present invention relates to a detector that includes a sensor adapted to pick up vibrations that are generated upon the slightest of disturbances which are created inevitably during any intrusion, theft, tampering or forced entry.

### BACKGROUND

Sensors are in use today to detect events such as the opening of doors or windows from their closed position or to detect the presence of human beings in restricted areas. These sensors can be used stand alone or be integrated with security systems. The prior art is replete with many such sensors and subsystems.

Standalone sensors are severely limited to generating an audible alert that can be effective only in the close proximity of the intrusion. Integrated subsystems existing today use more circuitry to process the signals from the sensors and convert them into an alert that is broadcast over telephonic lines. However these are designed to be mounted in fixed immovable structures such as homes where adequate power is available and are created in form factors which do not make them portable.

### SUMMARY OF THE INVENTION

The present invention discloses an intrusion detection system that detects any disturbance associated with intrusion or tampering and can provide local as well as long distance alerts over wireless and/or wired networks. Security systems available today can be defeated by careful examination of the sensor elements in the installed area and dismantling them or by using magnetic fields to override their behaviour. The novelty in this invention is that it uses vibration sensing to detect intrusion which is almost impossible to not generate while accessing anything. Moreover the fact that it is portable (can be used indoors or outdoors without a wall socket nearby) and alerts the owner of intrusion irrespective of whether the user is nearby or half way around the globe makes it unique. The invention is also a low power circuit design which is a critical enabler to its portability and versatility making it suitable for a very wide range of applications. Examples of indoor usage include securing lockers, cabinets or cupboards in a home/office with antiques/valuables, museum pieces with exquisite collections or expensive jewelry or simply put, anything that is of value to the user that no one else other than the owner of these items should come in contact with. A provision to disable local alerts via a key fob when the user returns to retrieve the valuable is provided in this embodiment of the design. Outdoor applications could include securing expensive automobiles, or RV's from thieves or tents/temporary storage sheds from animals encountered when outdoor. The user experience with this device can be increased manifold by using the device's mobile application on their smart phones. The usage of such an application is purely optional and is not a requirement to utilize the features of this device as detailed in this invention.

### BRIEF DESCRIPTION OF DRAWINGS

These and other features, benefits and advantages of the present invention will become apparent by reference to the following text and figures, with like reference numbers referring to like structures across the view, wherein

FIG. 1 is a block diagram of the device in accordance with an embodiment of the invention;

FIG. 2 illustrates a block diagram of the communication system of the device in accordance with an embodiment of the invention;

FIG. 3 illustrates a block diagram of a microcontroller of the device in accordance with an embodiment of the invention;

FIG. 4 illustrates a flow chart for the detection method in accordance with an embodiment of the invention;

FIG. 5 illustrates the said device along with its key fob, according to the invention.

### DETAILED DESCRIPTION OF THE INVENTION

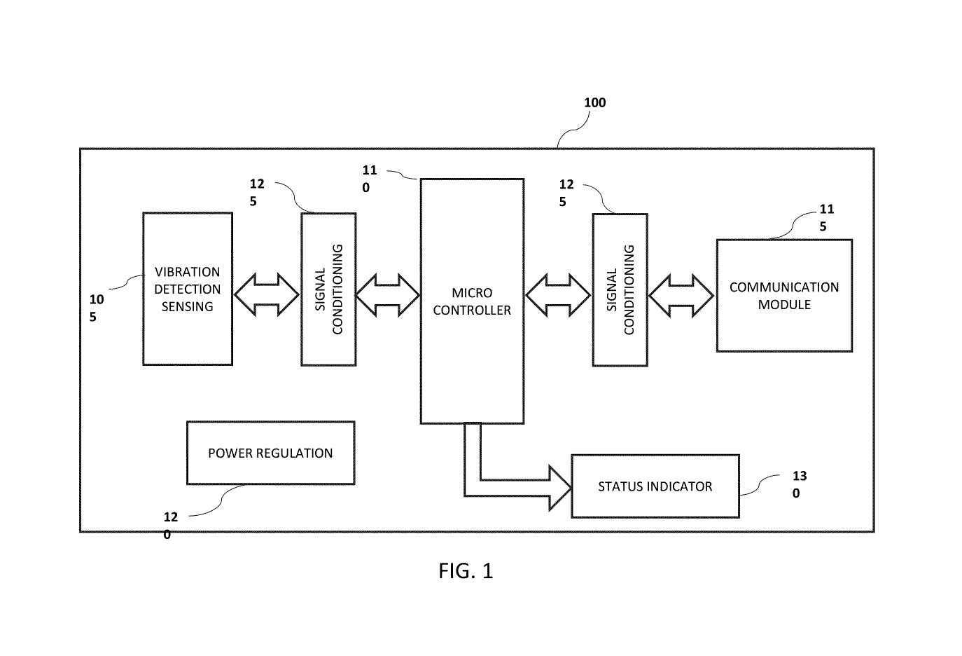

In accordance with the invention, the device 100 (as depicted in FIG. 1) is adapted to detect intrusion by picking up vibrations created by pilfering/tampering of any sort. The device 100 analyses the characteristics of a change in the voltage of a sensing element 105 to determine if the change is indicative of pilfering/tampering. Appropriate filtering is to be applied to suit different embodiments of this invention.

FIG. 1 illustrates a block diagram of the device 100. It includes a sensing element 105, a microcontroller 110, a communications module 115 for transmitting or receiving alerts and/or data and a power regulation module 120. In other embodiments of the invention the power regulation module may be from an internal power source such as a battery.

The sensing element 105 is constructed from a solid-state sensor though other types of sensing elements that are mechanical in nature can also be used in other embodiments of the invention. The sensing element is interfaced with the microcontroller through a signal conditioning block 125, as depicted. The voltage change as a function of time is monitored by the microcontroller 110, which applies filtering to eliminate noise sources from causing false triggers. Different thresholds for the magnitude and frequency of voltage change are implemented in the filtering to make the invention suitable for a varied range of applications both indoor and outdoor. To make the design robust, the device is first calibrated to establish a reference. The sensing element 105, is maintained in an always ON state to provide continual protection. The communication module 115, is responsible for communicating alerts generated by the microcontroller upon detection of intrusion. Depending on the embodiment of the invention, the alert could be in the form of audio/visual indicators only or could include transmitting the alert over a long range media such as a wired network and/or a wireless cellular communication network. The communication module is interfaced to the microcontroller through a signal conditioning block 125, as depicted. This module is managed by the microcontroller and is initialized once per power up and a health check is performed to ensure readiness to communicate any alert. If the module fails the health check, error indications are displayed prominently in the status indicator module 130, for the user to intervene. In addition, the status indicator also presents information on the readiness of the device to begin monitoring as well as indicating battery status information.

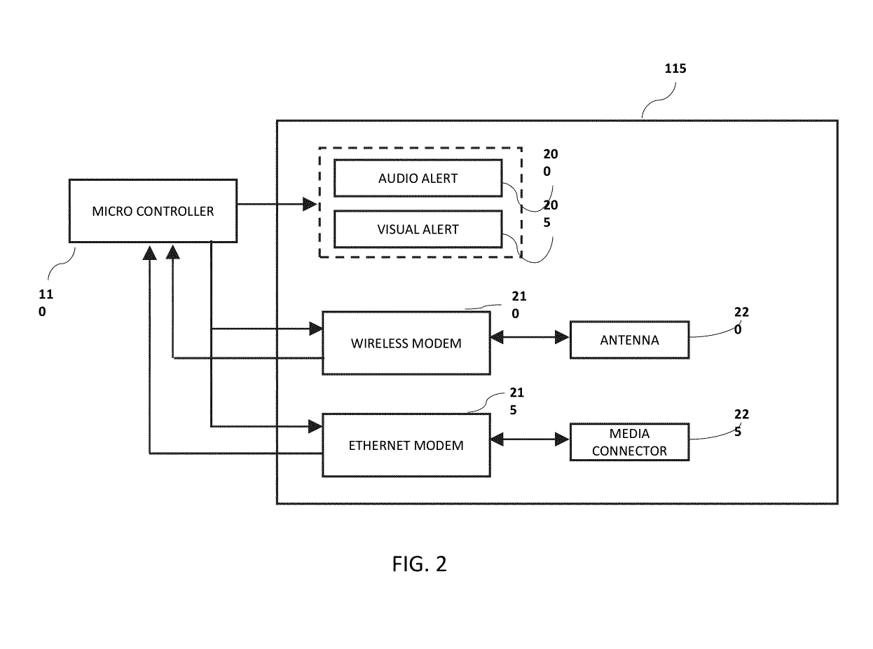

FIG. 2 illustrates a block diagram of the communications module 115. This module generates local and/or long distance alerts when the microcontroller 110 triggers an alert upon detecting intrusion. It comprises of a wireless modem 210 and its associated antenna 220. When a wired LAN option is available, an Ethernet modem 215 along with its media connector 225 may be installed. An audio module 200, which comprises of a speaker and a buzzer to generate local alerts is included. The visual alert module 205, can be included to generate visual alerts if the embodiment requires it.

The wireless modem 210 is responsible for generating a long distance alert. It is a solid state device that transmits a pre-scripted short message alert that it receives from the microcontroller over a valid cellular network. The transmission can also be in the form of email alerts when a valid data network is available. Depending on the user's preference, a single or multiple alerts could be generated to a single or multiple receiving addresses. The device is power managed and is maintained in a standby state when not in use in order to conserve power and extend battery life. The communication with the microcontroller is via a serial interface with signal conditioning on it thereby bringing about electrical compatibility between the modem and the microcontroller. This modem operates in receive mode when the user desires to configure the device. This is a novel distinguishing feature of this invention as it gives it the ability to accept user inputs in some of the embodiments without utilizing a keypad or LCD screen.

The antenna 220, should accompany the modem 210 in all embodiments of the invention that require long distance alerts. The antenna could be external and/or could be concealed in the casing of the device itself and would serve to improve reception quality and hence the reliability of the device as a security solution. When installed, the Ethernet modem 215 and its associated connector 225, would function in a manner very similar to the wireless modem and transmit/receive alerts and information over a LAN network.

While the wireless and Ethernet modems serve to communicate an alert over long distance media, the audio and visual modules 200 and 205 respectively, generate a local alert to deter intruders. In some other embodiments of the invention both types of modems could be eliminated and only these alerts could be employed. The alerts would be modulated in tone and frequency based on the embodiment of the invention. The time duration of the alert would also be set based on the application.

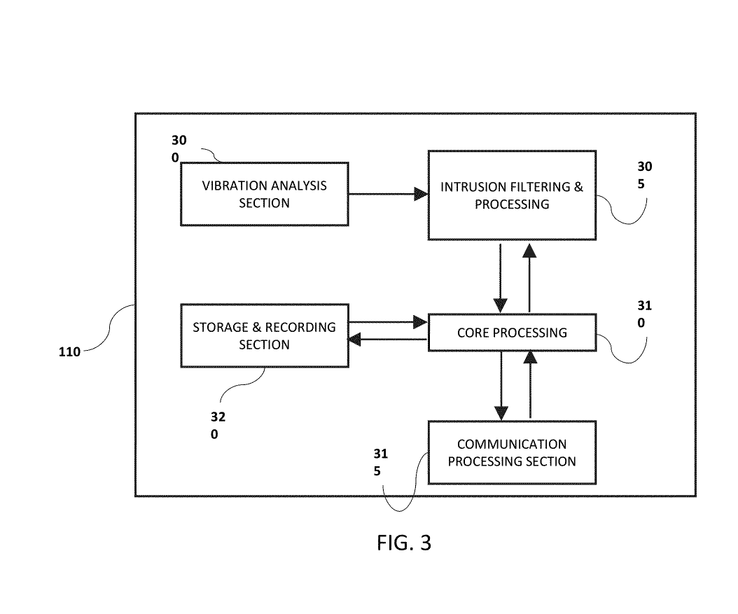

FIG. 3 is a block diagram of the functional blocks in the microcontroller in accordance with an embodiment of the invention. The microcontroller is programmed with firmware that enables the microcontroller 110 to perform the described functionality therein. As depicted in FIG. 3, the microcontroller 110 includes a vibration analysis section 300, an intrusion filtering and processing section 305, a core processing section 310, a communication processing section 315, and a storage and recording section 320. The implementation of various pre-set thresholds and filtering is implemented by sections 300 and 305. The core processing section 310 is the main routine that integrates all the functions together. The initial behaviour of the system based on the mode of operation chosen by the user, all the processing necessary to generate alerts when section 305 indicates the occurrence of an intrusion, interfacing with the communications modules and transferring information and data to the recording/storing section is done by the core processing module. The communication processing module delivers all the configuration and data commands required by the modems to transmit and/or receive information/alerts. The storage and recording section 320, handles the creation, maintenance and retrieval of subscriber information to which alerts are sent to and information is received from. The necessary parsing and data conditioning is performed on the fly prior to storage of various records. The storage in this embodiment of the invention happens to be the memory space provided by the internal EEPROM of the microcontroller itself. In other embodiments of this invention, more elaborate storage sub systems such as Flash memory could be utilized to store/record several events that are of interest to the user. In other embodiments of this invention, the triggers for generating recording events can come from various other sensing elements other than the one described by 105 thereby expanding the utility of this invention manifold.

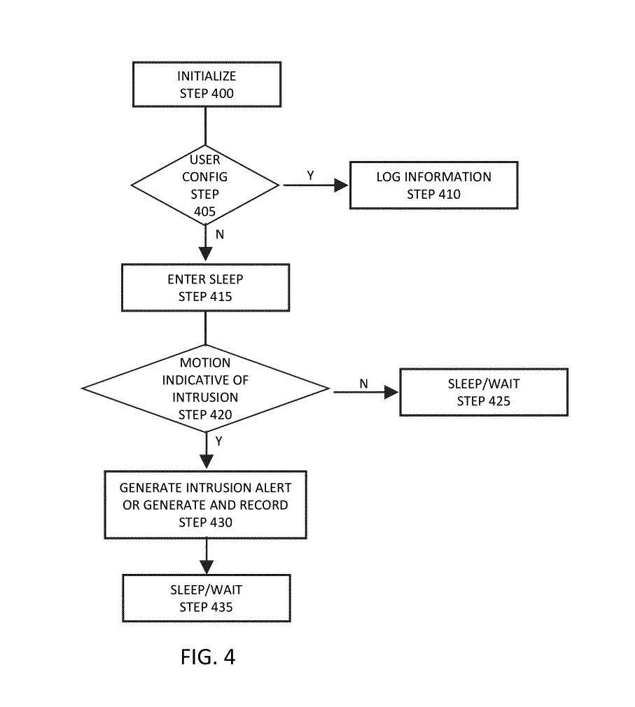

FIG. 4 illustrates a flow chart for a vibration based intrusion detection method according to an embodiment of the invention.

At step 400, the core processing module 310, initializes the sensing element and the communications modules if present. At step 405, the check for the user's intent is performed. If the user desires to edit/configure the device, the process ends at step 410, where the data received is logged and stored in the permanent storage space such as an EEPROM. If at step 405, the user intent is to use the device for intrusion detection when the user is not around, the process executes step 415, where the core processing puts the microcontroller in a low power “sleep” mode while being prepared to be interrupted by the sensing element upon detection of any vibration. The interrupt is configured to be level sensitive to improve noise immunity and prevent false triggers from creating interrupts to the controller. Upon receiving a valid interrupt, step 420 is executed where the interrupt is compared against a set of parameters that are determined based on the application where this invention is utilized. If the interrupt does not qualify to be intrusion, the process culminates at step 425, where the system returns to the sleep state awaiting future interrupts. If the interrupt passes the test, step 430, is executed where the communication modules are exercised to generate long distance and/or local alerts via different media as described in earlier sections. Upon completion of the alert broadcast, the process culminates in step 435, where the system re-enters sleep state awaiting future interrupts again.

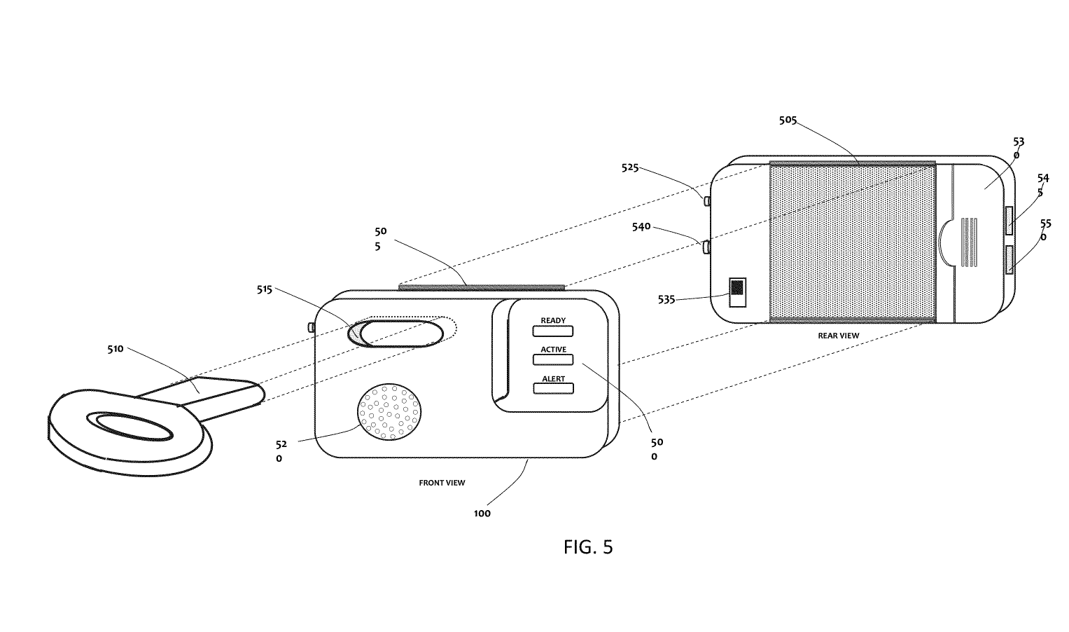

FIG. 5 illustrates the security device that serves as the intrusion detector, according to the invention. The device 100 is to be affixed to any asset/door/cupboard that needs to be protected by means of adhesive tape or hook and loop fasteners as depicted by 505. The key fob 510, is designed to be inserted into the key slot 515, whenever the user desires to silence the local alarm. The device 100 may include an audio interface 520, and visual indicators 500, to convey the status of the device. The audio interface is capable of full duplex communication and can transmit ambient sound as well as playback the voice of the user when triggered. This enables the user to screen calls and talk back to startle an intruder. This is another key benefit of this invention as it makes the device extremely effective in deterring intrusions. The device includes a battery compartment 530, which would house replaceable batteries. A power switch 535, to enable and disable the device is provided. A provision for adding an optional external antenna for use in areas with poor reception is also provided as depicted by 525.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. An apparatus for detecting intrusion of a place or asset, comprising:
a vibration detector;
a transmitter and receiver;
a siren;
a key fob; and
a control for controlling the vibration detector and transmitter to transmit a signal to alert a user upon generation of vibrations.

2. The apparatus of claim 1, further comprising:
a control section for controlling the receiver to receive a user command;
wherein the control is responsive to the user command for controlling the delivery of the alert by the transmitter

3. The apparatus of claim 2, wherein:
the user command sets a sensitivity level for the vibration detector.

4. The apparatus of claim 1, further comprising:
a portable housing in which the vibration detector, the transmitter, receiver and control are provided;
a battery provided in the portable housing for powering the control and transmitter.

5. The apparatus of claim 4, further comprising:
an adhesive tape, hook and loop fastener for securing the portable housing onto any asset, entry door, cupboard door or equipment

6. The method for detecting intrusion or tampering by picking up vibrations from the object it is attached to according to claim 5

7. The method for communicating the occurrence of intrusion from the object it is affixed to according to claim 6, comprising the step of activating a first alarm via a siren, a second alarm over a wireless cellular network and a third over a wired network connection

8. The method for performing claim 7 with an external power source if available or independently with portable power when a wall socket is not available.

9. The method to suppress audible alerts when the designated key is inserted into the device by the user.

10. The method for configuring and communicating with the device per claim 7, using basic functionalities of a mobile phone or by means of a custom application on the user's smart phone.

11. The method to establish a full duplex communication with the device using a mobile phone as per claim 10, with which the user can listen in and talk through the microphone and speaker integrated into the device whenever an intrusion occurs
